(19) United States
(12) Patent Application Publication
(10) Pub. No.: US 2016/0321771 A1
(43) Pub. Date: Nov. 3, 2016

(54) RIDE-SHARING RANGE CONTOURS

(71) Applicant: Ford Global Technologies, LLC, Dearborn, MI (US)

(72) Inventors: Yimin Liu, Ann Arbor, MI (US); Perry Robinson MacNeille, Lathrup Village, MI (US); Jinjing Yang, Ypsilanti, MI (US)

(21) Appl. No.: 14/699,226

(22) Filed: Apr. 29, 2015

(51) Int. Cl. G06Q 50/30; G01C 21/34; G06Q 30/02; G07B 15/00; G06Q 30/06

(52) U.S. Cl. CPC G06Q 50/30; G07B 15/00; G06Q 30/0613; G06Q 30/0283; G01C 21/3438

(57) ABSTRACT

A ride-sharing server may identify a set of ride-sharing users within a range contour indicative of a threshold of at least one of cost, and time and the number of occupants surrounding a driver route; send a set of ride-sharing options to a driver device, the ride-sharing options indicating the ride-sharing users; send a set of ride-sharing options to a rider device; and receive, from the driver device, a selection of one of the ride-sharing options to pick up one of the ride-sharing users; receive, from the ride device, a selection of one of the ride-sharing options to reserve one of the ride-sharing drivers or cancellation of a selection. A mobile device may receive, from the ride-sharing server, the set of ride-sharing options; display a user interface including the ride-sharing options; receive a selection of one of the ride-sharing options to pick up one of the ride-sharing users; and send the selection to the ride-sharing server.

### TECHNICAL FIELD

Aspects of the disclosure generally relate to a multi-modal transportation system allowing for trip planning, bidding, displaying, and trip reservation, including identification of range contours for use in ridesharing.

### BACKGROUND

A multi-modal transportation system is a system in which goods or passengers may be transported using multiple modes of transportation. These modes of transportation may include, as some examples, buses, trains, airplanes, cars, bicycles, boats (e.g., ferries, cruise lines, etc.) and even walking, and may include travel over paths such as roads, rails, monorails, tunnels, water, and air. Multi-modal transportation systems may foster competition between transportation modes such as between mass transit, multi-individual transit, and individual transit. Which transportation mode becomes dominant may depend on cultural, financial, geographic, occupant, and resource constraints. Many urban areas include multi-modal transportation systems including a hybrid of mass and individual transit systems interconnected at transportation hubs.

### SUMMARY

In a first illustrative embodiment, a system includes a ride-sharing server configured to identify a set of ride-sharing users as within a range contour indicative of a threshold of at least one of cost and time surrounding a driver route; send the set of ride-sharing options to a driver device, the ride-sharing options indicating the ride-sharing users; and receive a selection from the device of one of the ride-sharing options indicative of selection to pick up one of the ride-sharing users.

In a second illustrative embodiment, a system includes a mobile device configured to receive, from a ride-sharing server, a set of ride-sharing options indicating ride-sharing users within a range contour indicative of a threshold of at least one of cost and time surrounding a driver route; display a user interface including the ride-sharing options; receive a selection of one of the ride-sharing options to pick up one of the ride-sharing users; and send the selection to the ride-sharing server.

In a third illustrative embodiment, a computer-implemented method includes receiving driver user locations from a driver mobile device associated with a vehicle traversing a driver route; receiving ride-sharing user locations from a passenger mobile device of a ride-sharing user; identifying pickup of the ride-sharing user according to commonality in the driver and ride-sharing user locations; and sending a request to at least one of the driver mobile device and the passenger mobile device to confirm the pickup.

### BRIEF DESCRIPTION OF THE DRAWINGS

FIG. 1 illustrates an example diagram including a vehicle configured to access telematics servers and a mobile device having a trip-planning application;

FIG. 2A illustrates an example logical diagram of a multi-modal transportation system;

FIG. 2B illustrates an example network diagram of the multi-modal transportation system;

FIG. 3 illustrates an example user interface of the trip-planning application displaying a route and range contours overlaid on a map;

FIG. 4 illustrates an example data set including a plurality of ride-sharing options along the route;

FIG. 5 illustrates an example user interface of the trip-planning application for selection of ride-sharing options; and

FIG. 6 illustrates an example process for performing ride sharing for a plurality of users of the multi-modal transportation system; and

FIG. 7 illustrates an example process for accepting ride sharing by a non-driving user of the multi-modal transportation system.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A multi-modal transportation system may be a system in which goods or passengers may be transported using multiple modes of transportation, such as on foot, bicycles, motorcycles, cars, buses, aircraft, watercraft and railroad trains, that are owned or leased by the traveler, or part of an ownership group the partner belongs to or are available for rent or hire. The multi-modal transportation system may include strings of multi-modal hubs connected, for example, by a rail-based mass transit system or a bus-based rapid transit system. The hubs may include features such as parking lots and rental lots, with the rental lot including storage for vehicles such as cars, motorcycles and bicycles. Around each hub may be roads, bicycle lanes and walkways so commuters may travel between hubs or to and from hubs and destinations using bicycles, rental cars or walking. In many cases, at least some of the modes of transportation operate on paths dedicated to that mode of transportation.

A ride-sharing system may include a trip-planning application installed to user's mobile devices. When the user's mobile device is within wireless transmission range of a vehicle, the trip-planning application may be configured to connect to and integrate with an in-vehicle computing platform of the vehicle. The trip-planning application may be configured to perform route optimization in accordance with information received from the connected vehicle, such as global positioning information. The trip-planning application may be configured to facilitate ride-sharing decision-making by taking into account the status of vehicle routes across the modes of transportation, and differences among costs, time, and other factors, such as the riders' characteristics, route policy (e.g., carpool lane, parking, speed limits, vehicle weight and size), and the number of vehicle occupants. Ride-sharing drivers using the trip-planning application may accordingly understand trade-offs among those factors, and make selections based on the recommendations (e.g., using the human-machine interface (HMI) of the vehicle, using the HMI of the user's mobile device, etc.). When out of range of a vehicle, the trip-planning application may be configured to operate autonomously, without integration with the vehicle HMI.

The system may be further configured to determine range contours for the driver ride-sharing users, as well as available vehicle options for the passenger ride-sharing users. These range contours may be calculated by finding an efficient route for a driver to a destination (e.g., routes using carpool lanes), identifying alternate routing points that encircle the route, and determining which riders could share the trip and be picked up or dropped off along the route. In an example, the contours may be formed by connecting points along each route which satisfy driver-provided ride-sharing constraints. In such a system, an amount of time required for transferring between transportation modes at hubs and an amount of space needed for personal vehicles and rental vehicles may be substantial. Since the system may be complicated, for riders and ride-providers, a display may be provided by the trip-planning application to facilitate user identification of rides and riders. Further aspects of the multi-modal transportation system and trip-planning application are discussed in detail herein.

This application is related to commonly-assigned applications Ser. No. ______/Attorney Docket No. 83518974, filed concurrently herewith and titled “RIDE-SHARING USER PATH DISTURBANCES AND USER RE-ROUTING”; Ser. No. ______/ Attorney Docket No. 83519020, filed concurrently herewith and titled “RIDE-SHARING ROUTING USING CONTEXTUAL CONSTRAINTS”; Ser. No. ______/Attorney Docket No. 83519032, filed concurrently herewith and titled “RIDE-SHARING LONG-TERM RIDE-SHARE GROUPS”; and Ser. No. ______/ Attorney Docket No. 83519041, filed concurrently herewith and titled “RIDE-SHARING JOINT-RENTAL GROUPS”, each of which is incorporated in its entirety herein by reference.

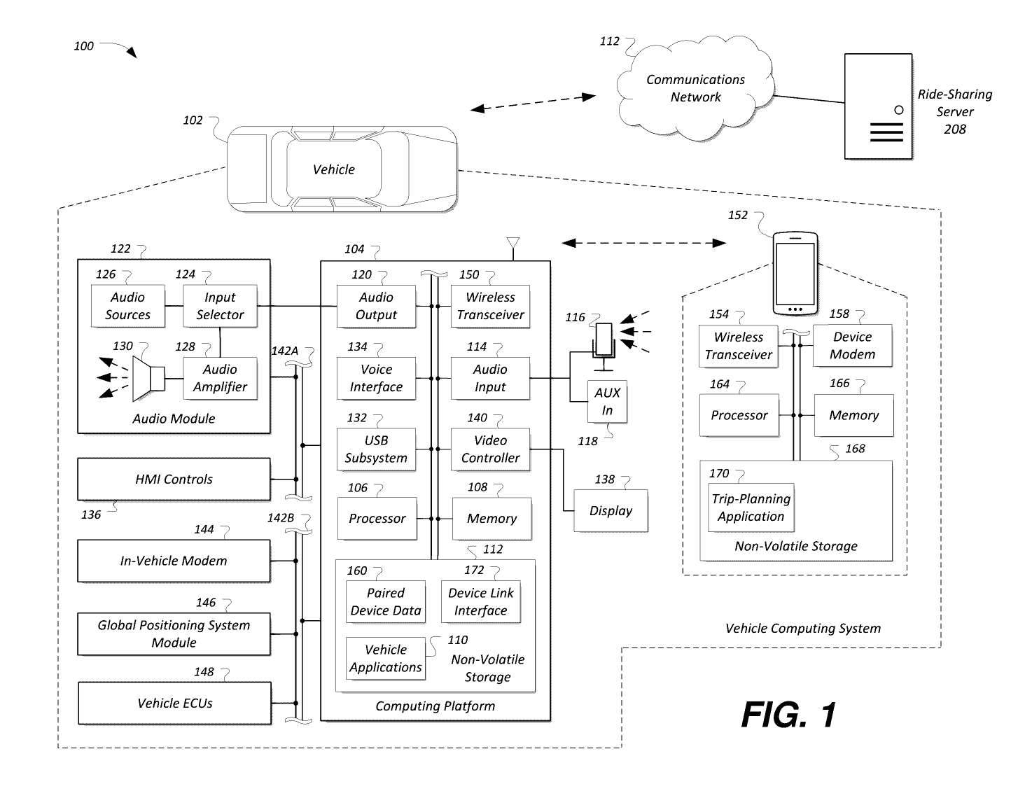

FIG. 1 illustrates an example system 100 including a vehicle 102 configured to access telematics servers and a mobile device 152 having a trip-planning application 170. The vehicle 102 may include various types of passenger vehicles, such as crossover utility vehicle (CUV), sport utility vehicle (SUV), truck, recreational vehicle (RV), boat, plane or other mobile machine for transporting people or goods. Telematics services may include, as some non-limiting possibilities, navigation, turn-by-turn directions, vehicle health reports, local business search, accident reporting, and hands-free calling. In an example, the vehicle 102 may include the SYNC system manufactured by The Ford Motor Company of Dearborn, Mich. It should be noted that the illustrated system 100 is merely an example, and more, fewer, and/or differently located elements may be used.

The computing platform 104 may include one or more processors 106 configured to perform instructions, commands and other routines in support of the processes described herein. For instance, the computing platform 104 may be configured to execute instructions of vehicle applications 110 to provide features such as navigation, accident reporting, satellite radio decoding, and hands-free calling. Such instructions and other data may be maintained in a non-volatile manner using a variety of types of computer-readable storage medium 112. The computer-readable medium 112 (also referred to as a processor-readable medium or storage) includes any non-transitory medium (e.g., a tangible medium) that participates in providing instructions or other data that may be read by the processor 106 of the computing platform 104. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

The computing platform 104 may be provided with various features allowing the vehicle occupants to interface with the computing platform 104. For example, the computing platform 104 may include an audio input 114 configured to receive spoken commands from vehicle occupants through a connected microphone 116, and auxiliary audio input 118 configured to receive audio signals from connected devices. The auxiliary audio input 118 may be a physical connection, such as an electrical wire or a fiber optic cable, or a wireless input, such as a BLUETOOTH audio connection. In some examples, the audio input 114 may be configured to provide audio processing capabilities, such as pre-amplification of low-level signals, and conversion of analog inputs into digital data for processing by the processor 106.

The computing platform 104 may also provide one or more audio outputs 120 to an input of an audio module 122 having audio playback functionality. In other examples, the computing platform 104 may provide the audio output to an occupant through use of one or more dedicated speakers (not illustrated). The audio module 122 may include an input selector 124 configured to provide audio content from a selected audio source 126 to an audio amplifier 128 for playback through vehicle speakers 130 or headphones (not illustrated). The audio sources 126 may include, as some examples, decoded amplitude modulated (AM) or frequency modulated (FM) radio signals, and audio signals from compact disc (CD) or digital versatile disk (DVD) audio playback. The audio sources 126 may also include audio received from the computing platform 104, such as audio content generated by the computing platform 104, audio content decoded from flash memory drives connected to a universal serial bus (USB) subsystem 132 of the computing platform 104, and audio content passed through the computing platform 104 from the auxiliary audio input 118.

The computing platform 104 may utilize a voice interface 134 to provide a hands-free interface to the computing platform 104. An example spoken dialog system is described in U.S. Pat. No 8,400,332, which is incorporated in its entirety by reference herein. The voice interface 134 may support speech recognition from audio received via the microphone 116 according to grammar associated with available commands, and voice prompt generation for output via the audio module 122. The voice interface 134 may utilize probabilistic voice recognition techniques using the grammar in comparison to the input speech. In many cases, the voice interface 134 may include a standard user profile tuning for use by the voice recognition functions to allow the voice recognition to be tuned to provide good results on average, resulting in positive experiences for the maximum number of initial users. In some cases, the system may be configured to temporarily mute or otherwise override the audio source specified by the input selector 124 when an audio prompt is ready for presentation by the computing platform 104 and another audio source 126 is selected for playback.

In some examples, a push-to-talk button may be configured to cause voice interface 134 to begin speech recognition. In another example, an “Open Mic” feature may be implemented where the user simply begins to speak without pressing a button. This may be implemented with a voice operated switch (VOX) or with an advanced LVCSR engine that activates for a predetermined set of phrases or words (e.g., a name of the system followed by please, followed by one of a specific set of verbs). The voice interface 134 may also support barge-in, whereby the speech synthesizer begins to provide a prompt before the user has finished the sentence (which is typical of natural speech where a listener begins to speak as soon as they understand the sentence, but before it is completed). Barge-in may also allow a dialog system to intentionally initiate a dialog during moments of silence, or to interrupt and ongoing conversation. This may be used as a tactic for conveying urgency, thus getting the user's attention.

The computing platform 104 may also receive input from human-machine interface (HMI) controls 136 configured to provide for occupant interaction with the vehicle 102. For instance, the computing platform 104 may interface with one or more buttons or other HMI controls configured to invoke functions on the computing platform 104 (e.g., steering wheel audio buttons, a push-to-talk button, instrument panel controls, etc.). The computing platform 104 may also drive or otherwise communicate with one or more displays 138 configured to provide visual output to vehicle occupants by way of a video controller 140. In some cases, the display 138 may be a touch screen further configured to receive user touch input via the video controller 140, while in other cases the display 138 may be a display only, without touch input capabilities.

The computing platform 104 may be further configured to communicate with other components of the vehicle 102 via one or more in-vehicle networks 142. The in-vehicle networks 142 may include one or more of a vehicle controller area network (CAN), an Ethernet network, and a media oriented system transfer (MOST), as some examples. The in-vehicle networks 142 may allow the computing platform 104 to communicate with other vehicle 102 systems, such as a vehicle modem 144 (which may not be present in some configurations), a global positioning system (GPS) module 146 configured to provide current vehicle 102 location and heading information, and various vehicle ECUs 148 configured to incorporate with the computing platform 104. As some non-limiting possibilities, the vehicle ECUs 148 may include a powertrain control module configured to provide control of engine operating components (e.g., idle control components, fuel delivery components, emissions control components, etc.) and monitoring of engine operating components (e.g., status of engine diagnostic codes); a body control module configured to manage various power control functions such as exterior lighting, interior lighting, keyless entry, remote start, and point of access status verification (e.g., closure status of the hood, doors and/or trunk of the vehicle 102); a radio transceiver module configured to communicate with key fobs or other local vehicle 102 devices; and a climate control management module configured to provide control and monitoring of heating and cooling system components (e.g., compressor clutch and blower fan control, temperature sensor information, etc.).

As shown, the audio module 122 and the HMI controls 136 may communicate with the computing platform 104 over a first in-vehicle network 142-A, and the vehicle modem 144, GPS module 146, and vehicle ECUs 148 may communicate with the computing platform 104 over a second in-vehicle network 142-B. In other examples, the computing platform 104 may be connected to more or fewer in-vehicle networks 142. Additionally or alternately, one or more HMI controls 136 or other components may be connected to the computing platform 104 via different in-vehicle networks 142 than shown, or directly without connection to an in-vehicle network 142.

The computing platform 104 may also be configured to communicate with mobile devices 152 of the vehicle occupants. The mobile devices 152 may be any of various types of portable computing device, such as cellular phones, tablet computers, smart watches, laptop computers, portable music players, wearable devices, E-textiles or other devices capable of communication with the computing platform 104. In many examples, the computing platform 104 may include a wireless transceiver 150 (e.g., a BLUETOOTH module, a ZIGBEE transceiver, a Wi-Fi transceiver, an IrDA transceiver, an RFID transceiver, etc.) configured to communicate with a compatible wireless transceiver 154 of the mobile device 152. Additionally or alternately, the computing platform 104 may communicate with the mobile device 152 over a wired connection, such as via a USB connection between the mobile device 152 and the USB subsystem 132. In some examples the mobile device 152 may be battery powered, while in other cases the mobile device 152 may receive at least a portion of its power from the vehicle 102 via the wired connection.

The communications network 156 may provide communications services, such as packet-switched network services (e.g., Internet access, VoIP communication services), to devices connected to the communications network 156. An example of a communications network 156 may include a cellular telephone network. Mobile devices 152 may provide network connectivity to the communications network 156 via a device modem 158 of the mobile device 152. To facilitate the communications over the communications network 156, mobile devices 152 may be associated with unique device identifiers (e.g., mobile device numbers (MDNs), Internet protocol (IP) addresses, etc.) to identify the communications of the mobile devices 152 over the communications network 156. In some cases, occupants of the vehicle 102 or devices having permission to connect to the computing platform 104 may be identified by the computing platform 104 according to paired device data 160 maintained in the storage medium 112. The paired device data 160 may indicate, for example, the unique device identifiers of mobile devices 152 previously paired with the computing platform 104 of the vehicle 102, such that the computing platform 104 may automatically reconnected to the mobile devices 152 referenced in the paired device data 160 without user intervention. In some vehicles 102, the computing platform 104 wireless transceiver 154 may be configured to provide hotspot functionality to user's mobile devices 152.

When a mobile device 152 that supports network connectivity is paired with the computing platform 104, the mobile device 152 may allow the computing platform 104 to use the network connectivity of the device modem 158 to communicate over the communications network 156 with the remote telematics server 162 or other remote computing device. In one example, the computing platform 104 may utilize a data-over-voice plan or data plan of the mobile device 152 to communicate information between the computing platform 104 and the communications network 156. Additionally or alternately, the computing platform 104 may utilize the vehicle modem 144 to communicate information between the computing platform 104 and the communications network 156, without use of the communications facilities of the mobile device 152.

Similar to the computing platform 104, the mobile device 152 may include one or more processors 164 configured to execute instructions of mobile applications loaded to a memory 166 of the mobile device 152 from storage medium 168 of the mobile device 152. In some examples, the mobile applications may be configured to communicate with the computing platform 104 via the wireless transceiver 154 and with the remote telematics server 162 or other network services via the device modem 158. The computing platform 104 may also include a device link interface 172 to facilitate the integration of functionality of the mobile applications into the grammar of commands available via the voice interface 134. The device link interface 172 may also provide the mobile applications with access to vehicle information available to the computing platform 104 via the in-vehicle networks 142. An example of a device link interface 172 may be the SYNC APPLINK component of the SYNC system provided by The Ford Motor Company of Dearborn, Mich.

A trip-planning application 170 may be an example of an application installed to the mobile device 152 and configured to utilize the device link interface 172 to interact with the computing platform 104. When connected to the vehicle 102, the trip-planning application 170 may be configured to utilize information from vehicle sensors, actuators and electronic control units made available via the vehicle bus 142. The trip-planning application 170 may also be configured to operate when untethered from the vehicle 102, such as when the user is riding public transportation or walking. The trip-planning application 170 may be further configured to communicate with servers via the communications network 156, as discussed in detail below. The user may interact with the trip-planning application 170 through the HMI of the mobile device 152, via a web interface, or via the HMI of the vehicle 102, to avoid distraction while driving.

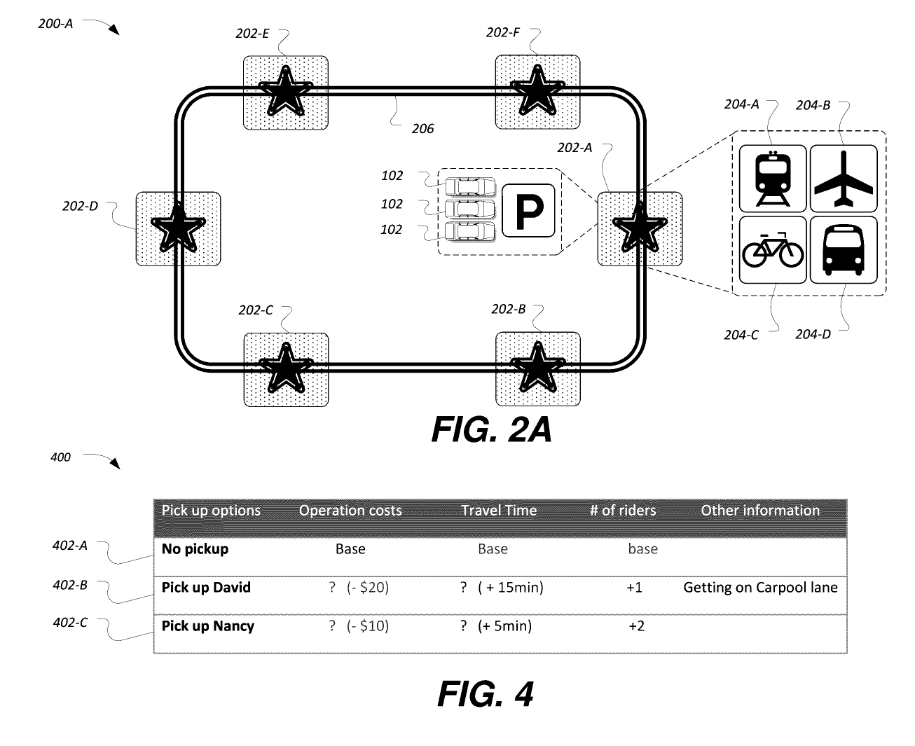

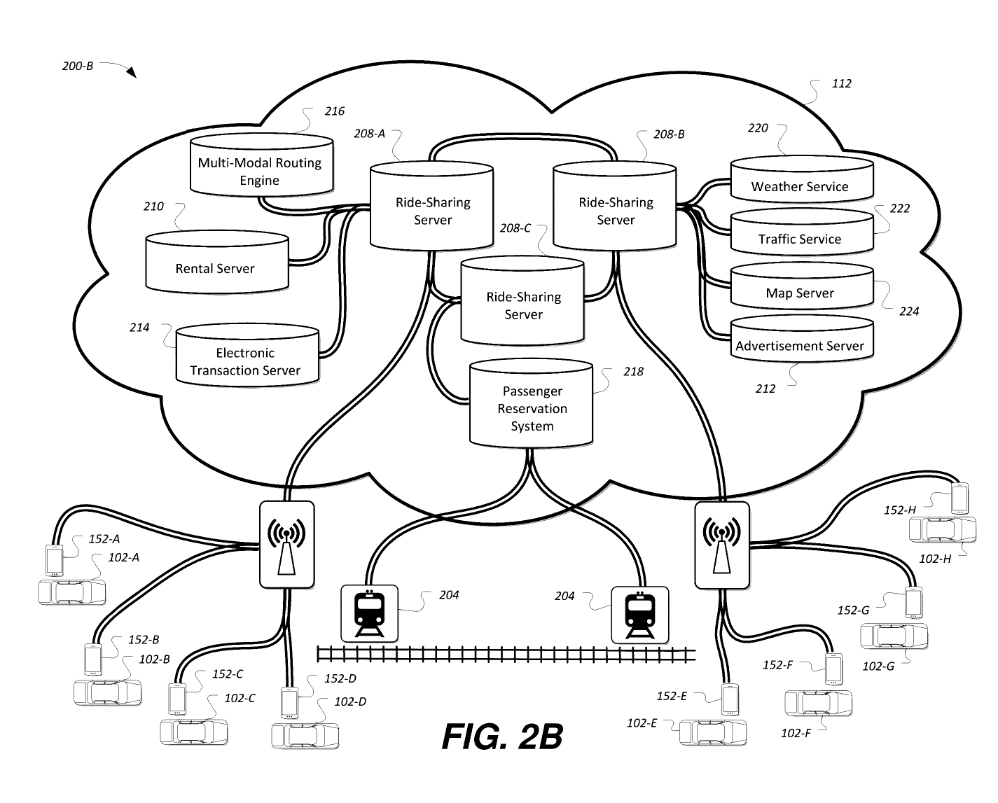

FIG. 2A illustrates an example logical diagram of a multi-modal transportation system 200. As shown, the multi-modal transportation system 200 may include multi-modal hubs 202-A through 202-F (collectively 202). The multi-modal hubs 202 may be connected by mass transportation systems 204, such as one or more of a rail-based mass transportation system (e.g., trains 204-A), an air-based mass transportation system (e.g., airplanes 204-B), a road-based transportation system (e.g., bicycles 204-C, buses 204-D, etc.), and a water-based transportation system (not pictured). The system 200 may include vehicles 102 such as cars, trucks, bicycles, train cars, or other transportation vehicles or devices, which may traverse paths 206 to facilitate the movement of users from location to location.

The hubs 202 may be configured to make the transportation systems 204 available to users of the system 200. The transportation systems 204 may include, as some possibilities, ride-sharing services, vehicle rental services, and bike rental services. These services may include a car sharing service such as the Zipcar subsidiary of Avis Budget Group of Cambridge, Mass., a bicycle sharing service such as the Hubway bicycle sharing system of Boston, Mass., a taxi service, or another service in which the vehicles 102 may rented or hired temporarily (e.g., using the mobile device 152) or utilized for a specific purpose or trip (e.g., a one-way trip). It should also be noted that in some cases the users may utilize their own vehicles 102. For instance, a driver may need to stop for a conference in a city and cannot or does not want to find parking, so the driver may make his or her vehicle 102 available for ridesharing until the owner desires to use the vehicle 102 again. The hubs 202 may be configured to store vehicles 102 of the transportations systems 204, such as rented or hired vehicles 102 awaiting a rider. The hubs 202 may be configured to store vehicles 102 of individuals, typically by lease or ownership. In an example, the hubs 202 may include a parking lot or other storage for individual-owned transit vehicles 102 (e.g., cars, trucks, bicycles, etc.) and a rental lot or other storage for storage of rental transit vehicles 102 (e.g., cars, motorcycles, bicycles, etc.). The hubs 202 additionally or alternately may include one or more of storage for aircraft, trains, etc. that are often not individually owned or leased, but are owned or leased by a firm or public authority.

The hubs 202 may further be located within proximity to one or more routable paths 206 (such as roads, bicycle lanes and walkways), such that users may traverse the paths 206 to travel between hubs 202 or between hubs 202 and other destinations using the vehicles 102 or walking. In some cases, the paths 206 may be shared across modes of transportation (e.g., personal vehicles 102 and taxi vehicles 102), while in other cases, the paths 206 may differ according to transportation mode (e.g., trains and buses traverse different paths 206). An ordered set of paths 206 that may be traversed by a user to travel from one location to another may be referred to herein as a route. It should be noted that terminology may varies between surface, nautical and aeronautical navigation. For instance, automobile routing systems may refer to an origin, a set of maneuvers, and a destination. There may further be waypoints connected by legs between each maneuver. A maneuver may be an intersection and waypoints between maneuvers describe the shape of the roads. Selection of a route may be done sequentially, e.g., by eliminating the least acceptable routes and introducing additional selective criteria and removing more unacceptable routes until one route is selected. However, unexpected or unlikely events may occur and a previously unacceptable route becomes preferred. With dynamic routing the route selection may change while underway.

FIG. 2B illustrates an example network diagram 200-B of the multi-modal transportation system 200. As shown, the communications network 156 may support communication between various components, such as mobile devices 152 of the users (whether in riding in vehicles 102 or not), ride-sharing servers 208-A, 208-B, 208-C (collectively 208), a rental server 210, an advertisement server 212, a transaction server 214, a multi-modal routing engine 216, a passenger reservation system 218, a weather service 220, a traffic service 222, and a map server 224. The system 200 may take many different forms and includes multiple and/or alternate components and facilities. While an exemplary system 200 is shown in FIG. 2B, the exemplary components illustrated of the system 200 are not intended to be limiting. Indeed, additional or alternative components and/or implementations may be used. As one example, some or all of the functionality of the multi-modal routing engine 216 may be integrated into the ride-sharing server 208.

The ride-sharing servers 208 may be configured to manage the vehicles 102 of the system 200. As shown, the multi-modal transportation system 200 includes a plurality of vehicles 102-A through 102-H (collectively 102) configured to communicate with the ride-sharing servers 208 (e.g., with or without use of the mobile device 152). The ride-sharing servers 208 may be configured to serve as points of contact for the users of the trip-planning application 170 to interact with the services of the multi-modal transportation system 200. These services may include, as some possibilities, dynamic intermediate transportation mode options, planning of trips for ride-sharing passengers and drivers (e.g., instant ridesharing, dynamic ridesharing, ad-hoc ridesharing, dynamic carpooling, etc.), and vehicle 102 position tracking. The ride-sharing servers 208 may be accordingly provide ride-sharing services to users of the system 200, allowing them to efficiently car-pool either within a hub 202 or upon arrival at a hub 202. This may accordingly speed movement through the transportation hub 202 by automatically finding ride-share partners while traveling on the mass transportation system 204 rather than trying to do an ad-hoc ride-share in the transportation hub 202, e.g., hailing a taxi upon arrival at an airport.

The ride-sharing servers 208 may further provide services to parties other than the users of the trip-planning application 170. For instance, the ride-sharing servers 208 may provide notification to the transportation systems 204 when a particular mode of transportation is selected by a user, which allows for allocation of vehicles 102 to routes for the users of the system 200. In another example, short-term rental vehicles 102 may be managed by a rental server 210. The short-term rental vehicles 102 may be booked by the users via the rental server 210 and the details of the rental (e.g., cost, days rented, etc.) may be provided to the ride-sharing servers 208 for use in facilitating ride-sharing using the rented vehicle 102. For instance, the ride-sharing servers 208 may identify rented vehicles 102 or ride-sharing vehicles 102 to be used for additional legs of a journey to users that have arrived in a hub 202 by a mass transit transportation system 204 and are in need of a vehicle 102 to ride-share in to travel between the transportation hub 202 and a final destination.

The advertisement server 212 may be configured to aggregate information from transportation systems 204 to attract users and to offer special discounts in return for inconvenience such as changing a trip time, etc. The advertisement server 212 may be further configured to provide a revenue stream to operate the system 200, although the system 200 may additionally or alternatively use a subscription model to meet operational and fixed costs.

The transaction server 214 may be configured to operate as a wallet server to provide travelers with a way to purchase tickets, rent vehicles 102, etc., from the user's mobile device 152. In an example, the transaction server 214 may be configured to manage account information for users of the system, to facilitate users making and receiving payment for sharing a vehicle 102, as well as to accumulate transactions over a billing cycle (e.g., 30 days, etc.), and provide a credit, disbursement, or bill to the user at the end of the billing cycle. Accordingly, the transaction server 214 may allow for financial aspects of the ride-sharing to be performed without cash or credit transactions being performed in the vehicles 102 or hubs 202, speeding movement through the transportation centers by avoiding stops at ticket counters, as an example.

The multi-modal routing engine 216 may be configured to provide routing services for the system 200 to identify travel times and paths 206 for a specific trip. As discussed in detail below, the multi-modal routing engine 216 may be further configured to determine range contours for the ride-sharing users. These range contours 308 may be calculated by finding an efficient route for a driver to a destination, identifying alternate routing points that encircle the route 306, and determining which riders could share the trip and be picked up or dropped off along the route 306. In an example, the contours 308 may be formed by connecting points along each route which satisfy driver-provided ride-sharing constraints.

The ride-sharing servers 208 may be further configured to communicate with other networked sources of information as well. In an example, the ride-sharing servers 208 may be configured to receive information from a passenger reservation system 218 of a transportation system 204, such as ticket information and train or other scheduling information. In another example, the ride-sharing servers 208 may be configured to receive information from a weather service 220 configured to provide information indicative of historical, current and/or forecast environmental conditions. In a further example, the ride-sharing servers 208 may be configured to receive information from a traffic service 222 configured to provide information indicative of historical, current and/or forecast traffic conditions along the paths 206. In yet a further example, the ride-sharing servers 208 may be configured to receive map information, such as path 206 information and route 306 information from the map server 224.

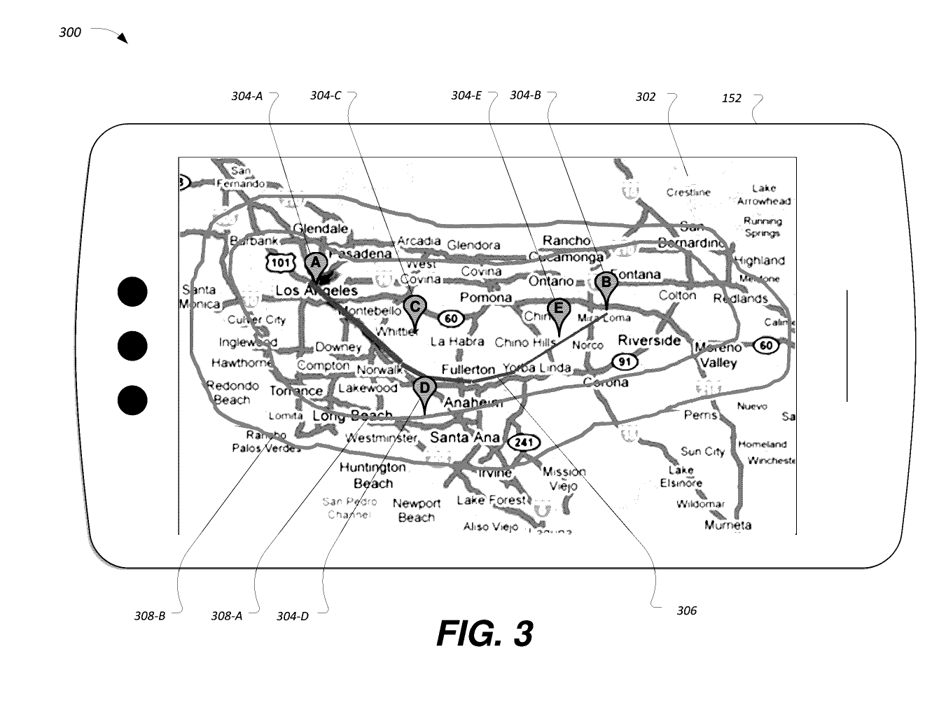

FIG. 3 illustrates an example user interface 300 of the trip-planning application 170 displaying a route 306 and range contours 308 overlaid on a map 302. The user interface 300 may be presented by the user trip-planning application 170 via a display of the mobile device 152. As another possibility, in instances where the mobile device 152 is connected to the computing platform 104 of the vehicle 102, the user interface 300 may be provided to the user via a display of the vehicle 102 via the vehicle-to-mobile device connection.

As illustrated in the user interface 300, the map 302 may illustrate a portion of the multi-modal transportation system 200. The route 306 may be overlaid on the map 302, and may further include one or more location indications 304. The route 306 may include an ordered set of one or more paths 206 that may be traversed by a user to get from one location indication 304 to another. The location indications 304 may accordingly indicate origin or destination locations of the user along the route 306, as well as locations of other users and other user destinations within the illustrated portion of the multi-modal transportation system 200. The range contours 308 may visually indicate thresholds of cost and/or time based on user settings that may be useful for the user of the trip-planning application 170 in determining whether to share the vehicle 102 with other users.

For example, consider a user of the trip-planning application 170 who is heading from location indication 304-A to location indication 304-B, and who has reserved a vehicle 102 from a rental server 210 in communication with a ride-sharing server 208. Along or near the user's route from location indication 304-A to location indication 304-B, there may be several other users who may also like to reach a destination along or near the route 306. In an example, a user “David” may be located at location indication 304-C and may wish to reach location indication 304-E. In another example, a user “Nancy” may be located at location indication 304-D and may also wish to reach location indication 304-E. As shown, the users at location indications 304-C and 304-D are near the route 306 from location indication 304-A to location indication 304-B and may be willing to either reserve their own vehicle 102 (e.g., via the vehicle 102 booking services of the ride-sharing server 208 and rental server 210), or ride-share as part of another user's trip (e.g., via the ride-sharing services of the ride-sharing server 208).

FIG. 4 illustrates an example data set 400 including a plurality of ride-sharing options 402 along the route 306. Before or during traversal of the route 306, the ride-sharing server 208 may be configured to send one or more ride-sharing options 402 to the trip-planning application 170 of the mobile device 152 of the user. These ride-sharing options 402 may include, for example, amounts of payments for sharing the vehicle 102, travel time difference estimates for sharing the vehicle 102, total number of riders, and other information regarding the potential ride-sharing options 402.

Continuing with the example from the user interface 300, the illustrated data set 400 indicates three ride-sharing options 402-A, 402-B and 402-C. The ride-sharing option 402-A may indicate aspects of a “no pickup” scenario in which no ride-sharing is performed, including a base operational cost (e.g., $50 in fuel and rental costs), a base travel time, and a base number of riders. In some examples, the data set 400 may include values provided by the ride-sharing server 208 for one or more of the operational cost, travel time, and count of riders, if known by the ride-sharing server 208. The travel time data may be computed, in an example, based on data for the route 306 available to the ride-sharing server 208, such as weather information retrieved or otherwise received from the weather service 220, traffic information for the paths 206 of the route retrieved or otherwise received from the traffic service 222, and information regarding the underlying paths 206 such as distance, speed limit, and average travel time. The operational cost data may be computed, in an example, based on data for the route 306 available to the ride-sharing server 208, such as the computed travel time data, fuel efficiency information for the vehicle 102 (e.g., based on vehicle 102 model or historical information retrieved from the rental server 210), fuel cost information (e.g., type/energy content of fuel, average gasoline price for a postal code or other local area in which the vehicle 102 is located (e.g., the location as determined according to the GPS module 146)), and daily, mileage, or other rental rate for the vehicle 102 retrieved from the rental server 210. As one possibility, the operational cost may be estimated as a stochastic variable with uncertainty due to distribution of driver behaviors. The operational cost may also consider Braess's paradox, and consider the operational cost to the system. For instance, for a driver a cost is time, for a person that fuels and maintains the vehicle 102 operational cost is may include monetary cost and time. For the transportation system operational cost may include impact on overall throughput of the system. A change in efficiency and/or change in throughput due to the ride-share may accordingly be considered in operational cost.

The ride-sharing option 402-B may include aspects of a scenario in which the driver user of the vehicle 102 additionally picks up the user “David” at the location indication 304-C, for drop off at the location indication 304-E. In some examples, the data set 400 may specify the aspects of the ride-sharing option 402-B as values relative to the ride-sharing option 402-A (or to the current ride-sharing options 402-A). For instance, in such an alternate scenario, the operational costs may decrease by $20 (e.g., due to payment to the driver user from David's account) the travel time may increase by fifteen minutes, and the number of riders may increase by one. In other examples, the data set 400 may specify the aspects of the ride-sharing option 402-B as independent values for each of the ride-sharing option 402. The data set 400 may further indicate other information, such as that, if the option 402-B is selected, carpool lanes may become available for use for the vehicle 102.

The ride-sharing option 402-C may include aspects of a scenario in which the driver user of the vehicle 102 picks up the user “Nancy” at the location indication 304-D for drop off at the location indication 304-E. For instance, in such an alternate scenario, the operational costs may decrease by $10 (e.g., due to payment to the driver user from Nancy's account) the travel time may increase by five minutes, and the number of riders may increase by two from the current count.

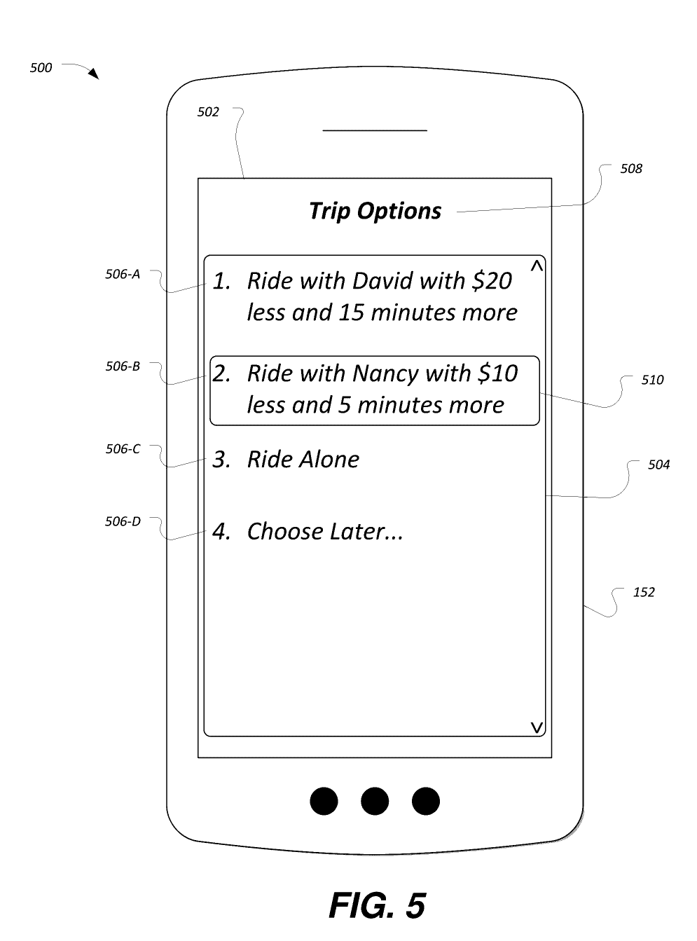

FIG. 5 illustrates an example user interface 500 of the trip-planning application 170 for selection of ride-sharing options 402. As illustrated, the user interface 500 may be presented to the user trip-planning application 170 via a display of the mobile device 152. As another possibility, the user interface 500 may be provided to the user via a display of a paired vehicle 102.

The user interface 500 may include a list control 504 configured to display a listing of the ride-sharing options 402 of the data criteria that may be selected by the user. As shown, each of the ride-sharing options 402 is displayed as one of several selectable list entries 506. The user interface 500 may also include a title label 508 to indicate to the user that the user interface 500 is for selection of the ride-sharing options 402.

As illustrated, the list control 504 of the trip-planning application 170 includes an entry 506-A for riding with David as specified in the ride-sharing option 402-B, an entry 506-B for riding with Nancy as specified in the ride-sharing option 402-C, an entry 506-C for continuing to ride alone 168 as specified in the ride-sharing option 402-A, and an entry 506-D for deferring the decision on whether to ride-share. It should be noted that the exact options, number of options, and options order is merely an example. For instance, in an alternate example the user interface 500 may prompt the user that “two persons on the route need to be picked up and would like to go to [location indication 304-E]; would you like to pick them up and save some costs?” (In other examples, it should be noted that the user interface 500 may be used by riders to select vehicles 102 in which to ride.)

The list control 504 may operate as a menu, such that a user of the user interface 500 may be able to scroll through list entries of the list control 504 to adjust a currently selected list entry 510 (e.g., using up and down arrow buttons) as well as to invoke the currently selected list entry 510 (e.g., using a select button). In some cases, the list control 504 may be displayed on a touch screen display, such that the user may be able to touch the list control 504 to select and invoke a menu item. As another example, the user interface 500 may support voice command selection of the menu items. For example, to select to pick up David, the user may press a push-to-talk button or say a voice command initiation keyword, and may speak the voice command “ride with David” or “choose ride sharing option 1.”

Responsive to the user selection, the trip-planning application 170 may be configured to send the selection to the ride-sharing server 208. The trip-planning application 170 may be further configured to provide location updates of the vehicle 102 location to the ride-sharing server 208, to allow the ride-sharing server 208 to provide updates to the other users regarding the status of the shared vehicle 102 ride.

In an example, when the vehicle 102 is traversing the route 306, and the location of the vehicle 102 (e.g., as determined via the GPS module 146) becomes within a predetermined threshold distance from the location indication 304-C, the trip-planning application 170 may be configured to flash or otherwise highlight the location indication 304-C displayed on the map 302 of the driver. Similarly, when users are riding within the vehicle 102, the users may be able to utilize the trip-planning application 170 to check a next leg of the route 306. For instance, if the user is scheduled to exit a first ride-sharing vehicle 102 to enter a second vehicle 102, the location of next ride-sharing vehicle 102 may be illustrated on the map 302 of the user.

Additionally or alternately, the ride-sharing server 208 may inform the user to be picked up (e.g., in this example, David) of the expected wait time for the vehicle arrival. In an example, a user waiting to be picked up may receive information from the ride-sharing server 208 with respect to the status of the pickup. In an example, the user awaiting pickup may utilize his or her mobile device 152 executing the trip-planning application 170 to view vehicle tracking information indicative of the location of the vehicle 102 that will be picking him or her up. As one additional or alternate possibility, the trip-planning application 170 may receive from the ride-sharing server 208 information indicative of the color, make, and/or model of the vehicle 102 to pick the user up. The information regarding the vehicle 102 performing the pickup may be accessed by the ride-sharing server 208 from the rental server 210.

Once the user or users have been picked up, the driver may utilize the trip-planning application 170 to inform the ride-sharing server 208 of the pickup. In an example, the user may select a command of the trip-planning application 170 (e.g., pressing a button indicating that the user(s) selected for pickup at the location indication 304 have been picked up). In another example, the user may utilize a voice command or other input mechanism to inform the trip-planning application 170. Additionally or alternately, the user who is picked up may report using his or her mobile device 152 trip-planning application 170 that he or she has been picked up by the vehicle 102. As yet a further additional or alternate example, the trip-planning applications 170 of the driver and of the user(s) to be picked up may both send location updates to the ride-sharing server 208, and the ride-sharing server 208 may infer based on the commonality in location change that the users are riding in the vehicle 102 together.

It should be noted that the monetary aspects of the transaction between the driver and the users who are sharing the ride may be performed using the services of the ride-sharing server 208. For instance, rather than having a monetary transaction take place between the driver and the ride-sharer, the ride-sharing server 208 may be configured to inform the transaction server 214 to transfer funds from an account of the ride-sharer to an account of the driver. In another example, the ride-sharing server 208 and/or transaction server 214 may accumulate transactions over a billing cycle (e.g., 30 days, etc.), and may provide a credit, disbursement, or bill to the user at the end of the billing cycle. In another example, a crypto currency or scrip may be used to transfer funds, (e.g., the Octopus Card utilized in Hong Kong, the SMART Communication Pasaload utilized in the Philippines, Bitcoin, etc.). In some examples, transfers may be bundled and netted since multiple smaller transactions may offset one other.

Accordingly, the system 200 may save users costs and time, e.g., with additional occupants in the vehicle 102, the user could drive the vehicle 102 on car-pooling lane. The system 200 may also build on and reflect social networks or social relations among people. In addition, the users may be able to avoid privacy issues, as credit card and home address information is not shared with the driver of the vehicle 102 ferrying the ride-sharers to their destinations. Further, the system 200 may allow the riders to rate the drivers for future riders, allowing the riders to determine, when there are multiple drivers offering rides, which ride to choose based on rating or price.

Referring back to FIG. 3, the user interface 300 may be configured to display rider options and trade-offs to the driver. (E.g., the trip-planning application 170 may provide an option to allow a user to switch between the user interface 300 and the user interface 500.) In an example, the range contours 308 may illustrates how far the driver may travel go for a pick-up at different pick prices (e.g., a $20 contour) or time-costs (e.g., a 20 minute contour). In an example, the trip-planning application 170 may allow the user to edit the specific criteria used for generation of the range contours 308. As shown, the range contour 308-A may be based on the criterion of routes worth approximately $20, and the range contour 308-B may be based on the criterion of routes worth approximately $30. It should be noted that the illustrated range contours 308 are merely examples, and more, fewer, and/or range contours 308 having different criteria may be used.

Similar to the computation of the operational cost and travel time for the ride-sharing options 402 of the data set 400, the range contours 308 may be computed based on ride-sharing server 208 based on various data elements. When modeling the range contours 308, the ride-sharing server 208 may utilize the map data to locate points along the route 306 and on other paths spreading down roads branching away from the route 306.

To create the range contours 308, the ride-sharing server 208 may be configured to connect the points on the route 306 and adjacent paths having equal estimates pick-prices or time-costs. In an example, for computation of a travel-time-based range contour 308, the bounds of the range contour 308 may be computed for the points on the route 306 and adjacent paths using information available to the ride-sharing server 208, such as weather information retrieved or otherwise received from the weather service 220, traffic information for the paths 206 retrieved or otherwise received from the traffic service 222, and information regarding the underlying paths 206 such as distance, speed limit, and average travel time. The operational-cost-based range contours 308 may be computed for the points on the route 306 and adjacent paths based on information available to the ride-sharing server 208, such as the computed travel time data, fuel efficiency information for the vehicle 102 (e.g., based on vehicle 102 model or historical information retrieved from the rental server 210), fuel cost information (e.g., average gasoline price for a postal code or other local area in which the vehicle 102 is located (e.g., the location as determined according to the GPS module 146)), and daily, mileage, or other rental rate for the vehicle 102 retrieved from the rental server 210.

The range contour 308 may accordingly provide visual indications of cost or time in the user interface 300 that may be relevant for determining which, if any, of the ride-sharing options 402 to select from the user interface 500. For drivers, the range contour 308 may provide insight into how to minimize the total time of a route 306 or minimizing the total costs of traveling the route 306.

In an example, the trip-planning application 170 may be configured to provide a suggestion to the driver of which, if any of the ride-sharing options 402 to select. To do so, the trip-planning application 170 may minimize the available possibilities for time, such as by computing which of the ride-sharing options 402 would provide a shortest estimated time. In some cases, for example due to availability of car-pooling lanes, the option having a shortest estimated time may include picking up one or more ride sharers. If minimizing costs, the trip-planning application 170 computing which of the ride-sharing options 402 would provide a lowest estimated cost, or a highest return. In some cases, this may be not simply to pick up all the ride-sharers as, for instance, some riders may elect to pay a higher fee to be more desirable for pickup, and other riders may simply cost more than the benefit they may provide to the driver (e.g., cause the vehicle 102 to be delayed such that travel costs more than overcome the amount the rider would pay).

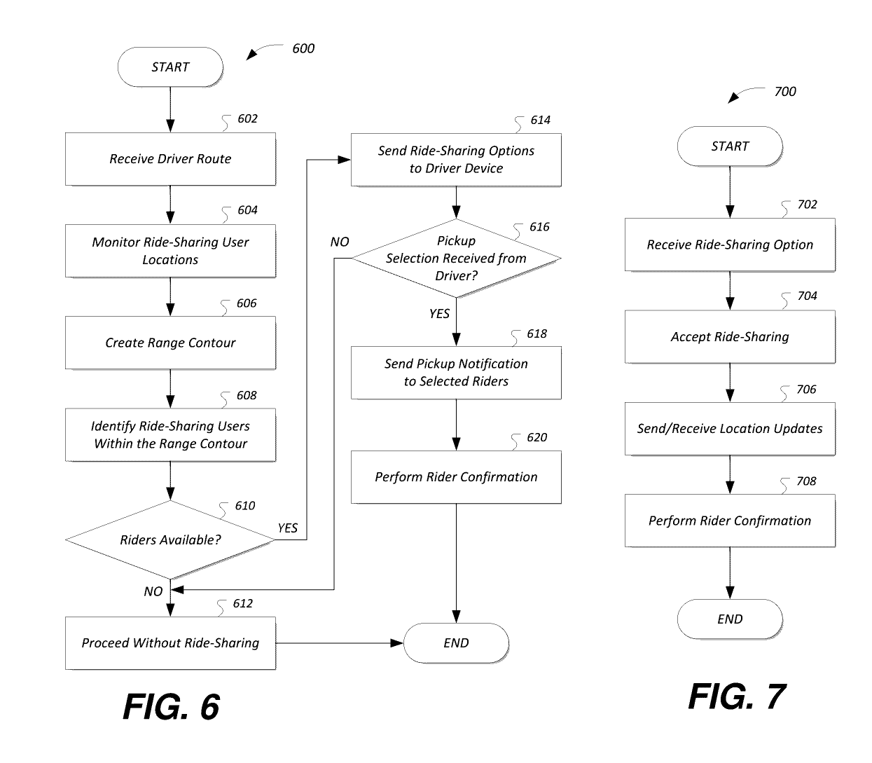

FIG. 6 illustrates an example process 600 for performing ride sharing for a plurality of users of the multi-modal transportation system 200. In an example, the process 600 may be performed by the ride-sharing server 208.

At operation 602, the ride-sharing server 208 receives a route 306 from a trip-planning application 170 of a driver. In an example, a driver may rent a vehicle 102 from a vehicle 102 rental service, and the ride-sharing server 208 may be informed of the rental via a rental server 210 of the rental service. The trip-planning application 170 may be installed to the driver's mobile device 152, and the mobile device 152 may be paired with the rented vehicle 102. The driver may further enter the route 306 to the trip-planning application 170. The ride-sharing server 208 may receive the route 306, which may be sent by the trip-planning application 170 to the ride-sharing server 208. In another example, the driver may enter a destination, and the trip-planning application 170 may provide an origin location of the user (e.g., current location, location of a hub 202, etc.) and the destination location to the ride-sharing server 208 to compute the route 306.

At operation 604, the ride-sharing server 208 monitors locations of one or more ride-sharing users seeking to share a ride. In an example, the trip-planning application 170 may be installed to ride-sharing user's mobile devices 152, and the ride-sharing server 208 receive location information of the mobile devices 152 sent by the trip-planning application 170. The location information may be determined, for example, by GPS functionality of the mobile devices 152.

At operation 606, the ride-sharing server 208 creates range contours 308 for the route 306. In an example, the ride-sharing server 208 may generate one or more range contours 308 at user-specified pick prices (e.g., a $20 contour) or time-costs (e.g., a 20-minute contour).

At operation 608, the ride-sharing server 208 identifies ride-sharing users within the range contour 308. In an example, the ride-sharing server 208 may compare the monitored locations of the one or more ride-sharing users with the range contours 308 to determine which users may be located within the range contour 308.

At operation 610, the ride-sharing server 208 determines whether any ride-sharing users are available within the range contour 308. If users are identified, control passes to operation 614. Otherwise, control passes to operation 612.

At operation 612, the ride-sharing server 208 proceeds without ride-sharing. After operation 612, the process 600 ends. In some examples, control may instead pass to operation 608 to identify whether additional ride sharing users have become available within the range contour 308.

At operation 614, the ride-sharing server 208 sends ride-sharing options 402 to the trip-planning application 170 of the driver. In an example, the ride-sharing server 208 may send a data set 400 including a plurality of ride-sharing options 402 to the trip-planning application 170 of the driver. An example data set 400 is described above with respect to FIG. 4.

At operation 616, the ride-sharing server 208 determines whether selection of one or more of the ride-sharing options 402 was performed. In an example, the driver may select one or more of the ride-sharing options 402 using the user interface 500 of the trip-planning application 170 as described above with respect to FIG. 5. Responsive to such a selection, of the trip-planning application 170 of the driver may send, and the ride-sharing server 208 may receive, an indication of the selection performed by the driver. If the driver selected one or more of the ride-sharing options 402, control passes to operation 618. Otherwise, control passes to operation 612.

At operation 618, the ride-sharing server 208 sends a pickup notification to the selected riders. In an example, the ride-sharing server 208 may send, to the trip-planning application 170 of the ride-sharing user waiting to be picked up, a pickup notification from the ride-sharing server 208 with respect to the status of the pickup. For instance, the pickup notification may include information regarding the vehicle 102 of the driver, such as the color, make, and/or model.

At operation 620, the ride-sharing server 208 performs rider confirmation. In an example, the ride-sharing server 208 may receive confirmation entered by the driver using his or her trip-planning application 170 to inform the ride-sharing server 208 of the pickup. Additionally or alternately, the user who is picked up may report using his or her mobile device 152 trip-planning application 170 that he or she has been picked up by the vehicle 102. As yet a further additional or alternate example, the trip-planning applications 170 of the driver and of the user(s) to be picked up may both send location updates to the ride-sharing server 208, and the ride-sharing server 208 may infer based on the commonality in location change that the users are riding in the vehicle 102 together. After operation 620, the process 600 ends.

FIG. 7 illustrates an example process 700 for accepting ride sharing by a non-driving user of the multi-modal transportation system 200. In an example, the process 700 may be performed by the mobile device 152 of a user in communication with the ride-sharing server 208.

At operation 702, the mobile device 152 receives one or more ride-sharing options 402. In an example, the trip-planning application 170 may receive a data set 400 including a plurality of ride-sharing options 402 from the ride-sharing server 208. An example data set 400 is described above with respect to FIG. 4.

At operation 704, the mobile device 152 accepts one or more of the ride-sharing options 402. In an example, the trip-planning application 170 displays a user interface to the user, and received input from the user indicating acceptance of one or more of the ride-sharing options 402. An example user interface 500 is described above with respect to FIG. 5.

At operation 706, the mobile device 152 sends and/or receives location updates. In an example, the trip-planning application 170 may provide location updates of the vehicle 102 location to the ride-sharing server 208, to allow the ride-sharing server 208 to provide updates to the other users regarding the status of the shared vehicle 102 ride. In another example, the trip-planning application 170 may receive vehicle tracking information from the ride-sharing server 208 indicative of the location of the vehicle 102 that will be picking him or her up.

At operation 708, the mobile device 152 performs rider confirmation, examples of which are described above with respect to operation 620. After operation 708, the process 700 ends.

Thus, the multi-modal transportation system 200 may allow for identify a set of ride-sharing users as within a range contour indicative of a threshold maximum of at least one of cost and time surrounding a driver route; send a set of ride-sharing options to a driver device, the ride-sharing options indicating the ride-sharing users; and receive, from the device, a selection to pick up one of the ride-sharing users.

Variations on the multi-modal transportation system 200 are possible. In an example, the ride-sharing server 208 may also send the data set 400 including the plurality of ride-sharing options 402 to the trip-planning application 170 of the riders, allowing the riders to select from the of ride-sharing options 402 instead of or in addition to selection by the driver. Moreover, when selecting whether to ride, the trip-planning application 170 may display information indicative of how many seats are available within the vehicle 102 as well as the locations of those seats within the vehicle 102. As another variation, the ride-sharing options 402 may include information regarding the constraints on the number of occupants of the vehicle 102, e.g., to aid in determining how many users to selection for inclusion. As yet a further possibility, when a vehicle 102 reaches maximum rider capacity, additional riders may disappear from display on the user interface 300.

As another possibility, the multi-modal transportation system 200 may aid riders in reserving a next trip. For instance, a rider confirmation for a future trip may be pre-scheduled using the trip-planning application 170. As yet another possibility, the ride-sharing driver may intend to exit the vehicle 102 to attend an event, e.g. conference, but may be unable or unwilling to locate parking. In such an example the ride-sharing driver may choose a rider to take the role as driver to use the vehicle 102 during that time, and return the vehicle 102 back to the original driver once the event is complete.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a ride-sharing server configured to
identify a set of ride-sharing users as within a range contour indicative of a threshold maximum of at least one of cost and time surrounding a driver route;
send a set of ride-sharing options to a driver device, the ride-sharing options indicating the ride-sharing users; and
receive, from the device, a selection to pick up one of the ride-sharing users.

2. The system of claim 1, wherein the ride-sharing server is further configured to
receive driver user locations from a vehicle traversing the driver route; and
send the driver user locations to the driver device to the one of the ride-sharing users selected for pickup.

3. The system of claim 1, wherein the ride-sharing server is further configured to send a pickup notification to the one of the ride-sharing users responsive to the selection.

4. The system of claim 1, wherein the range contour is defined according to at least one of a predetermined rider cost threshold and a predetermined time cost threshold.

5. The system of claim 1, wherein the set of ride-sharing options includes number of occupants, rider cost and time cost information for the ride-sharing users.

6. The system of claim 5, wherein the rider cost and time cost information is specified in the set of ride-sharing options as cost and time offsets from a currently-selected set of ride-sharers.

7. The system of claim 1, wherein the ride-sharing server is further configured to:
receive ride-sharing user locations from mobile devices of the ride-sharing users; and
identify the set of ride-sharing users within the range contour according to the ride-sharing user locations.

8. A system comprising:
a mobile device configured to
receive, from a ride-sharing server, a set of ride-sharing options indicating ride-sharing users within a range contour indicative of a threshold of at least one of cost and time surrounding a driver route;
display a user interface including the ride-sharing options;
receive a selection of one of the ride-sharing options to pick up one of the ride-sharing users; and
send the selection to the ride-sharing server.

9. The system of claim 8, wherein the mobile device is further configured to display the driver route and the range contour overlaid on a map.

10. The system of claim 9, wherein the mobile device is further configured to:
receive ride-sharing user locations from the ride-sharing server; and
identify the ride-sharing users within the range contour according to the ride-sharing user locations.

11. The system of claim 8, wherein the mobile device is further configured to send driver user locations of the mobile device to the ride-sharing server to be provided to ride-sharing users selected for pickup.

12. The system of claim 8, wherein the range contour is defined according to at least one of a predetermined rider cost threshold and a predetermined time cost threshold.

13. The system of claim 8, wherein the set of ride-sharing options includes number of occupants, rider, cost and time cost information for the ride-sharing users.

14. The system of claim 13, wherein the rider, cost and time cost information is specified in the set of ride-sharing options as cost differences from a currently-selected set of ride-sharers.

15. The system of claim 13, wherein the mobile device is further configured to present at least two of the number of occupants, rider cost, and time cost information specified in the set of ride-sharing options in the user interface.

16. A computer-implemented method comprising:
receiving driver user locations from a driver mobile device associated with a vehicle traversing a driver route;
receiving ride-sharing user locations from a passenger mobile device of a ride-sharing user;
identifying pickup of the ride-sharing user according to commonality in the driver and ride-sharing user locations; and
sending a request to at least one of the driver mobile device and the passenger mobile device to confirm the pickup.

17. The method of claim 16, further comprising sending the driver user locations to the passenger mobile device to inform the ride-sharing user of progress of the vehicle alone the driver route.

18. The method of claim 16, further comprising:
querying a rental server for vehicle information indicative of at least two of a make, a model, and a color of the vehicle; and
sending the vehicle information to the passenger mobile device to aid the ride-sharing user in identifying the vehicle.

19. The method of claim 16, further comprising:
sending a set of ride-sharing options to the driver mobile device, the ride-sharing options identifying a set of ride-sharing users within a range contour available for ride-sharing; and
receive, from the device, a selection of one of the ride-sharing options to pick up one of the ride-sharing users.

20. The method of claim 19, further comprising identifying the set of ride-sharing users within the range contour as being those users within a threshold of at least one of cost and time surrounding the driver route.
